(19) United States
(12) Patent Application Publication
(10) Pub. No.: US 2018/0025562 A1
(43) Pub. Date: Jan. 25, 2018

(54) SMART DOOR

(71) Applicant: Intel Corporation, Santa Clara, CA (US)

(72) Inventor: Xin Gill Chen, Shanghai (CN)

(21) Appl. No.: 15/471,440

(22) Filed: Mar. 28, 2017

Related U.S. Application Data
(60) Provisional application No. 62/365,655, filed on Jul. 22, 2016.

(51) Int. Cl. G07C 9/00; G06K 9/00; H04N 7/18

(52) U.S. Cl. CPC G07C 9/00158; H04N 7/188; G06K 9/00335; G06K 9/00288; H04N 7/186; G07C 9/00563

(57) ABSTRACT

A device associated with a door for implementing a smart door system is proposed in this disclosure. The device comprises a sensor circuit comprising one or more sensors configured to collect information associated with an object in a predefined area surrounding the door. The device further comprises a processing circuit configured to process the information from the one or more sensors and generate a control signal, based on the information from the one or more sensors. In some embodiments, the control signal is communicated to a user device. In some embodiments, the control signal indicates the user device about the presence of the object in the predefined area surrounding the door.

### REFERENCE TO RELATED APPLICATIONS

This application claims the benefit of provisional Application No. 62/365,655, filed Jul. 22, 2016, entitled “SMART DOOR”, the contents of which are herein incorporated by reference in their entirety.

### FIELD

The present disclosure relates to the field of home security systems, and more specifically to an apparatus and a method for implementing a smart door.

### BACKGROUND

Home safety and security is a top concern for most consumers and therefore, the home security industry is booming in this time of economic uncertainty and rising crime statistics. With more and more people being away from their homes for a considerable amount of time, the home security systems play a major role in the safety of your homes. With the advent of internet of things (IoT), there is a growing opportunity in integrating home security systems and IoT that make the home security systems smarter and easier to use.

### BRIEF DESCRIPTION OF THE DRAWINGS

Some examples of circuits, apparatuses and/or methods will be described in the following by way of example only. In this context, reference will be made to the accompanying Figures.

FIG. 1 illustrates a smart door system, according to one embodiment of the disclosure.

FIG. 2 illustrates a simplified block diagram of a device associated with a door in a smart door system, according to one embodiment of the disclosure.

FIG. 3 illustrates a flow diagram of a scenario of operation of a device associated with a door in a smart door system, according to one embodiment of the disclosure.

FIG. 4 illustrates a flow diagram of a scenario of operation of a device associated with a door in a smart door system, according to one embodiment of the disclosure.

FIG. 5 illustrates a flow diagram of a scenario of operation of a device associated with a door in a smart door system, according to one embodiment of the disclosure.

FIG. 6 illustrates a flow chart of a method of a device associated with a door in a smart door system, according to one embodiment of the disclosure.

FIG. 7 illustrates a flow chart of a method of a device associated with a door in a smart door system, according to one embodiment of the disclosure.

FIG. 8 illustrates a flow chart of a method of a device associated with a door in a smart door system, according to one embodiment of the disclosure.

FIG. 9 illustrates a flow chart of a method of a device associated with a door in a smart door system, according to one embodiment of the disclosure.

### DETAILED DESCRIPTION

In one embodiment of the disclosure, a device associated with a door is disclosed. The device comprises a sensor circuit comprising one or more sensors configured to collect information associated with an object in front of or in a predefined area surrounding the door. The device further comprises a processing circuit configured to process the information from the one or more sensors and generate a control signal for communicating to a user device, based on the information from the one or more sensors, wherein the control signal indicates the user device about the presence of the object in front of or in the predefined area surrounding the door.

In one embodiment of the disclosure, a device associated with a door is disclosed. The device comprises a sensor circuit comprising a camera configured to take a picture of an object in front of or in a predefined area surrounding the door. The device further comprises a processing circuit configured to process the picture from the camera, generate a control signal comprising the picture; and provide the control signal to a user device, wherein the control signal indicates the user device about the presence of the object in front of or in the predefined area surrounding the door.

In one embodiment of the disclosure, a device associated with a door is disclosed. The device comprises a sensor circuit comprising a gesture sensor configured to collect information comprising an identity of a person in a predefined area surrounding the door, in order to identify a specific person and at least one specific gesture associated with the specific person; a processing circuit configured to process information from the gesture sensor; generate a gesture control signal based on the information from the gesture sensor; and provide the gesture control signal to a first user device, based on the information associated with the control signal, wherein the control signal indicates the presence of an object in the predefined area surrounding the door; and a control circuit coupled to the processing circuit, in order to open the door.

In one embodiment of the disclosure, a method for a device associated with a door is disclosed. The method comprises collecting information comprising an identity of a person in a predefined area surrounding the door and at least one specific gesture associated with the person, at a sensor circuit comprising a gesture sensor; processing the information from the gesture sensor, at a processing circuit; generating a control signal based on the information from the gesture sensor, at the processing circuit; and providing the control signal from the processing circuit to a user device associated with a regulatory authority, based on the information associated with the control signal, wherein the control signal indicates the presence of an object in the predefined area surrounding the door.

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” “circuit” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.”

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

As indicated above, the home security systems play a major role in the safety of your homes. With the advent of internet of things (IoT), there is a growing opportunity in integrating home security systems and IoT that make the home security systems smarter and easier to use. The IoT is the internetworking of physical devices, also referred to as “connected devices” and “smart devices” that allows objects to be sensed and/or controlled remotely across existing network infrastructure. For example, in the case of a home network, various devices like refrigerator, washing machine, TV etc. can be part of the IoT and can be controlled remotely over the existing network architecture. This greatly reduces the human intervention, in addition to improving efficiency and accuracy of home network systems. This disclosure explores the idea of a smart door that integrates the IoT features to a door in the home network.

Current solutions in the market in the area of security solutions associated with a door includes finger print recognizer or facial recognizer. However, these solutions doesn't alert the home owner about the person/object in front of or in a predefined area surrounding the door and does not allow the home owner to control the door remotely. To overcome this issue, an apparatus and a method for implementing a smart door, is proposed in this disclosure. In some embodiments, the smart door enables to provide security to a home owner in an easier and efficient way, by alerting the home owner or others (e.g., a regulatory authority like police or 911) about objects (e.g., persons, animals) in front of or in the predefined area surrounding the door over existing network architecture, for example, internet. In some embodiments, the smart door further enables the home owner to remotely control the door (e.g., opening or closing of the door) over existing network architecture.

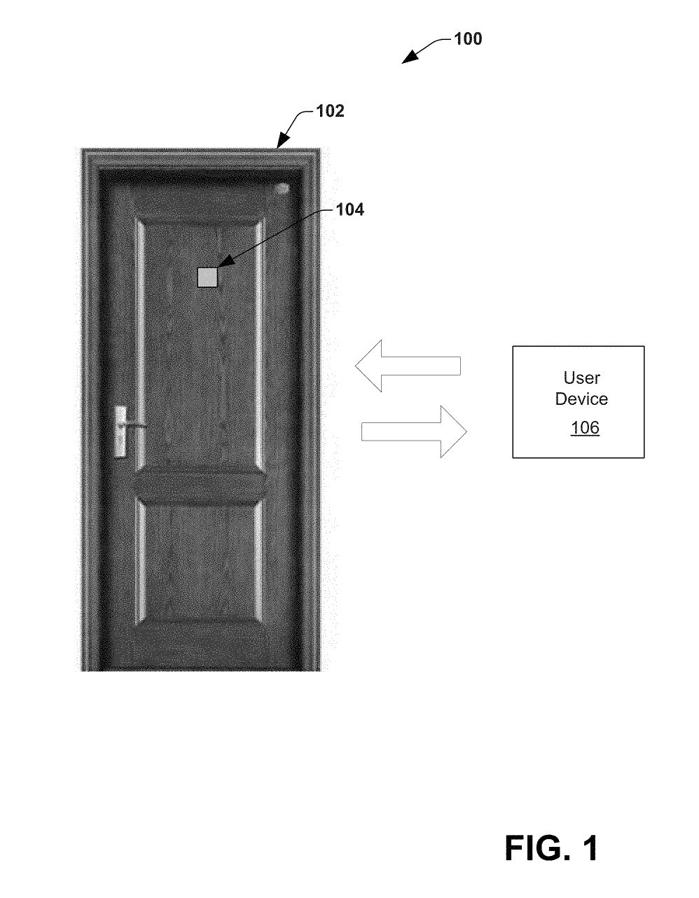

FIG. 1 illustrates a smart door system 100, according to one embodiment of the disclosure. The smart door system 100 comprises a door 102 and a user device 106. In this embodiment, a single user device 106 is illustrated to be part of the smart door system 100, however, in other embodiments, the smart door system can comprise multiple user devices. Alternately, in other embodiments, the user device 106 can comprise one or more user devices. In some embodiments, the door 102 comprises a device 104 configured to identify information associated with an object in front of the door 102 and provide an indication to the user device 106 about the object in front of the door 102. In other embodiments, however, upon determining the information associated with the object, the device 104 can choose not to provide the indication about the object to the user device 106. In some embodiments, the user device 106 can comprise a smart device associated with a user (e.g., smart phone, tablets etc.), however, in other embodiments, the user device 106 can comprise a device associated with a regulatory authority like police or 911. In some embodiments, the usage “in front of the door” utilized throughout the disclosure can include a predefined area surrounding the door 102. In such embodiments, the device 104 may be able to detect the presence of an object anywhere in the predefined area.

In some embodiments, the device 104 can comprise a sensor circuit comprising one or more sensors configured to collect the information associated the object in front of the door 102. In some embodiments, the device 104 may further comprise a processing circuit configured to process the information from the one or more sensors and generate a control signal based on the information. In some embodiments, when the sensor circuit comprises more than one sensor, the processing circuit can be configured to generate a specific control signal for each of the respective sensors. In some embodiments, the processing circuit may be further configured to provide the control signal to the user device 106, based on the information associated with the control signal. In the embodiments where the sensor circuit comprises more than one sensor, the processing circuit may be configured to provide the control signal associated with a first sensor to a first user device, and further provide the control signal associated with the second sensor to a second, different user device. In such embodiments, the user device 106 can comprise the first user device and the second user device. In some embodiments, the control signal provides an indication to the user device 106 about the presence of the object in front of the door 102. In some embodiments, the processing circuit may be further configured to receive a command signal from the user device 106, in response to providing the control signal to the user device 106. In some embodiments, the device 104 may further comprise a control circuit configured to open the door 102, based on the control signal or a signal associated therewith, for example, the command signal.

In some embodiments, the device can further include a communication circuit (e.g., microphone, speaker etc.) that facilitates communication (e.g., voice communication) between the object in front of the door 102 and the user device 106. In some embodiments, the device 102 may further include an interface circuit (e.g., a transmitter circuit or a receiver circuit) configured for communicating one or more signals (e.g., the control signal) between the processing circuit and the user device 106. In some embodiments, the one or more signals from the device 104 can be provided to the user device 106, over the existing network architecture (e.g., the internet). However, other modes of communication (e.g., voice call over a mobile operator's network) are also contemplated to be within the scope of this disclosure.

In some embodiments, the user device 106 can comprise one or more processors configured to process the control signal from the processing circuit and provide the command signal, in response to the control signal. In some embodiments, the command signal is generated at the user device 106, based on a user trigger. In some embodiments, the information associated with the control signal will be received at the user device 106 on an application (e.g., a mobile app) or email etc. Alternatively, in some embodiments, the information associated with the control signal will be received at the user device 106 as a voice call over a mobile operator's network. In some embodiments, the object may be a living being, for example, a human being or an animal, however, in other embodiments, the object can be a non-living matter, for example, a box. In some embodiments, the communication between the device 104 and the user device 106 may be wire based or wireless. Sensors or the device 104 itself associated with the door may be provided on the door 102 or adjacent to the door 102. In some embodiments, some parts associated with the device 102 may be provided on the door, while some other parts of the device 102 may be provided at remote location therefrom.

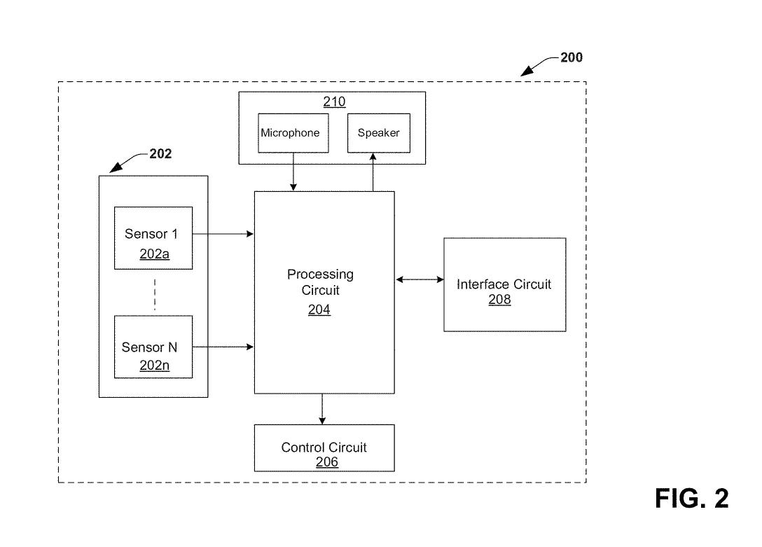

FIG. 2 illustrates a simplified block diagram of a device 200 associated with a door in a smart door system, according to one embodiment of the disclosure. In some embodiments, the device 200 is same as the device 104 in FIG. 1 or can be included with the device 104 in FIG. 1. The device 200 comprises a sensor circuit 202, a processing circuit 204 and a control circuit 206. In some embodiments, the device 200 further comprises an interface circuit 208 and a communication circuit 210. In some embodiments, the device 200 can be on a door (e.g., the door 102 in FIG. 1), whereas, in other embodiments, the device 200 can be adjacent to the door. Alternatively, in other embodiments, some parts of the device 200 can be on the door, while some parts can be at a location remote from the door. In some embodiments, the device 200 is configured to collect information associated with an object in front of the door (or within a predefined area surrounding the door). In some embodiments, the device 200 is further configured to provide one or more signals to a user device (e.g., the user device 106 in FIG. 1), wherein the one or more signals indicates the user device about the presence of the object in front of the door.

The sensor circuit 202 comprises one or more sensors configured to collect information of the object in front of or in the predefined area surrounding the door. In some embodiments, the sensor circuit 202 comprises a plurality of sensors, for example, sensor 1 . . . sensor N, however, in other embodiments, the sensor circuit 202 can comprise a single sensor. In some embodiments, the sensor circuit 202 can comprise a camera (not shown) configured to take a picture of the object in front of the door under some predetermined conditions. In other embodiments, the sensor circuit 202 can comprise a gesture sensor (not shown) configured to collect information comprising an identity of a person in front of the door and at least one specific gesture associated with the person. In some embodiments, the gesture sensor can comprise a gesture camera configured to take an image of the person in front of the door, in order to collect information comprising the identity of the person in front of the door and at least one specific gesture associated with the person. However, in other embodiments, the gesture sensor can be implemented differently.

In yet another embodiment, the sensor circuit 202 can comprise a chip reader, for example a near field communication (NFC) chip configured to identify a matching chip ID. In some embodiments, the matching chip ID can be associated with a chip implanted on an animal, for example, a pet, whereas, in other embodiments, the matching chip ID can be associated with any other chip, for example, a chip on a key card etc. In other embodiments, other kinds of sensors (e.g., but not limited to, infrared sensors to detect movement) can also be contemplated to be within the scope of this disclosure. In some embodiments, the sensor circuit 202 can comprise all of the above sensors, for example, the camera, the gesture sensor and the chip reader, however, in other embodiments, the sensor circuit 202 can comprise a predefined combination of the one or more sensors above.

The processing circuit 204 is coupled to the sensor circuit 202 and is configured to process the information from the one or more sensors associated with the sensor circuit 202. In some embodiments, the processing circuit 204 is further configured to generate a control signal based on the information from the one or more sensors associated with the sensor circuit 202. In some embodiments, the control signal generated at the processing circuit 204 based on the information from the sensor circuit 202 comprising the camera can be referred to as a picture control signal. Similarly, in some embodiments, the control signal generated at the processing circuit 204 based on the information from the sensor circuit 202 comprising the gesture sensor can be referred to as a gesture control signal. In some embodiments, the processing circuit 204 can comprise a memory circuit (not shown) associated therewith, wherein the memory circuit is configured to store instructions and data for generating the control signal. In some embodiments, the processing circuit is further configured to provide the control signal to a user device (not shown), external to the device 200, based on the information associated with the control signal.

In some embodiments, the control signal provides an indication to the user device about the presence of the object in front of the door. However, in other embodiments, the processing circuit 204 may not send the control signal to the user device. In some embodiments, the processing circuit 204 is configured to send the control signal to the user device via the interface circuit 208 (that can include a receive circuitry and a transmit circuitry). In some embodiments, the interface circuit 208 is further configured to receive on or more signals from the user device and provide the one or more signals to the processing circuit 204. In some embodiments, the processing circuit 204 is further configured to provide the control signal to the control circuit 206, in order to open the door (e.g., the door 102 in FIG. 1), based on the information associated with the control signal. However, in other embodiments, the processing circuit 204 can choose not to provide the control signal to the control circuit 206.

The control circuit 206 is coupled to the processing circuit 204 and is configured to open the door based on the control signal or a signal associated therewith. For example, in some embodiments, the control circuit 206 is configured to open the door, based on the control signal received from the processing circuit 204. However, in other embodiments, the control circuit 206 is configured to open the door based on a command signal received at the processing circuit 204 from the user device. In such embodiments, the control circuit 206 is configured to receive the control signal from the processing circuit 204, in order to open the door. In some embodiments, the command signal is generated at the user device, in response to providing the control signal to the user device by the processing circuit 204. In some embodiments, the command signal is generated at the user device based on a user command or trigger, in response to receiving the control signal. The communication circuit 210 is coupled to the processing circuit 204 and enables to provide communication between the object in front of the door and the user device. In some embodiments, the communication circuit 210 comprises one or more communication interfaces (e.g., microphone, speaker etc.) configured to provide communication between the user device and the object in front of the door. In some embodiments, the communication circuit 210 can be part of the sensor circuit 202.

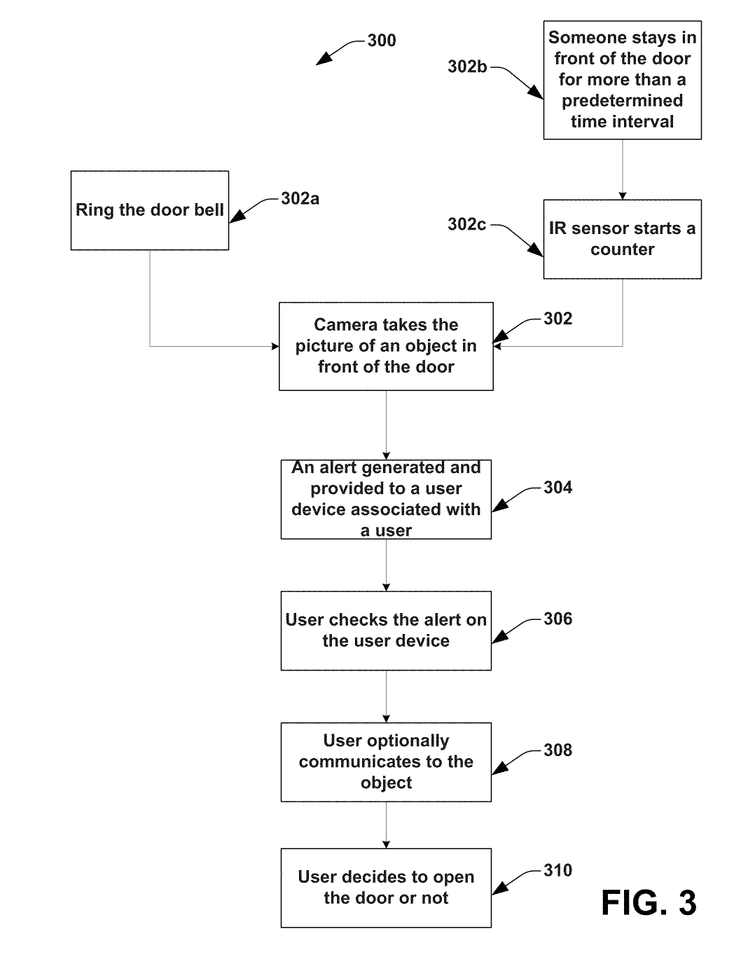

FIG. 3 illustrates a flow diagram 300 of a scenario of operation of a device associated with a door in a smart door system, according to one embodiment of the disclosure. In some embodiments, the device described herein is same as the device 200 in FIG. 2. In particular, the scenario of operation illustrated herein is applicable, when the sensor circuit 202 associated with the device 200 comprises a camera. The flow diagram 300 is explained herein with reference to the device 200 in FIG. 2. In this embodiment, the sensor circuit 202 associated with the device 200 is assumed to comprise a camera. At 402, the camera (i.e., the sensor circuit 202 in FIG. 2) takes the picture of the object in front of the door. In some embodiments, the camera is configured to take the picture of the object, when a door bell associated with the door is rung (as indicated in block 302a).

Alternately, in other embodiments, the camera is configured to take the picture of the object, when someone (e.g., a person or an object) stays in front of the door for more than a predetermined interval of time (e.g., 1 minute) as indicated in the block 302b. In such embodiments, the sensor circuit 202 can further comprise an infrared (IR) sensor configured to detect the presence of the object in front of the door. In some embodiments, the IR sensor is configured to trigger a counter to determine the time as indicated in block 302c. When the predetermined time interval is crossed, the camera is triggered to take the picture of the object. In some embodiments, the IR sensor comprises a processor associated therewith (e.g., a dedicated processor) configured to perform the above processing (triggering the counter, determining the time and triggering the camera). However, in other embodiments, the processor associated with the IR sensor can be a part of the processing circuit 204.

At 304, an alert is generated at the device 200 and provided to a user device associated with a user (e.g. the house owner or a predefined person). In such embodiments, the processing circuit 204 is configured to receive the picture from the camera (i.e., the sensor circuit 202) and generate a control signal (i.e., the alert) comprising the picture. The processing circuit 204 is further configured to provide the generated control signal to the user device. In some embodiments, the processing circuit 204 is configured to provide the generated control signal to the user device via the interface circuit 208. At 306, the user can check the alert (e.g., the alert or the picture associated with the control signal or both) on the user device. In some embodiments, the alert or the control signal is received at the user device via an application (e.g., but not limited to a mobile app) on the user device, over the internet. However, other modes of communication is also contemplated to be within the scope of this disclosure.

At 308, the user optionally communicates with the object. In such embodiments, upon seeing the picture associated with the control signal, the user can talk to the object through the user device. In some embodiments, the user voice signal is sent to the device 200, via the user device, over the internet. At the device 200, in some embodiments, the processing circuit 204 is configured to receive the user voice signal via the interface circuit 208, and provide the user voice signal to the object through the communication circuit 210. In such embodiments, the communication circuit 210 comprises a first communication interface, for example, a speaker to provide the user voice signal to the object. In some embodiments, the communication circuit 210 is also configured to receive an object voice signal from the object to be subsequently provided to the user device. In such embodiments, the communication circuit 210 comprises a second communication interface, for example, a microphone to receive the object voice signal from the object. In such embodiments, the processing circuit 204 is further configured to process the object voice signal and provide the object voice signal to the user device, via the interface circuit 208.

At 310, the user decides to open the door or not, based on the optional communication at 308 or based on checking the picture associated with the alert at 306. In such embodiments, if the user decides to open the door, the user is configured to trigger the user device to provide a command signal to the processing circuit 204, via the interface circuit 208, wherein the command signal is an indication to the device 200 to open the door. Upon receiving the command signal, the processing circuit 204 provides the command signal to the control circuit 206. Upon receiving the command signal, the control circuit 206 is configured to open the door.

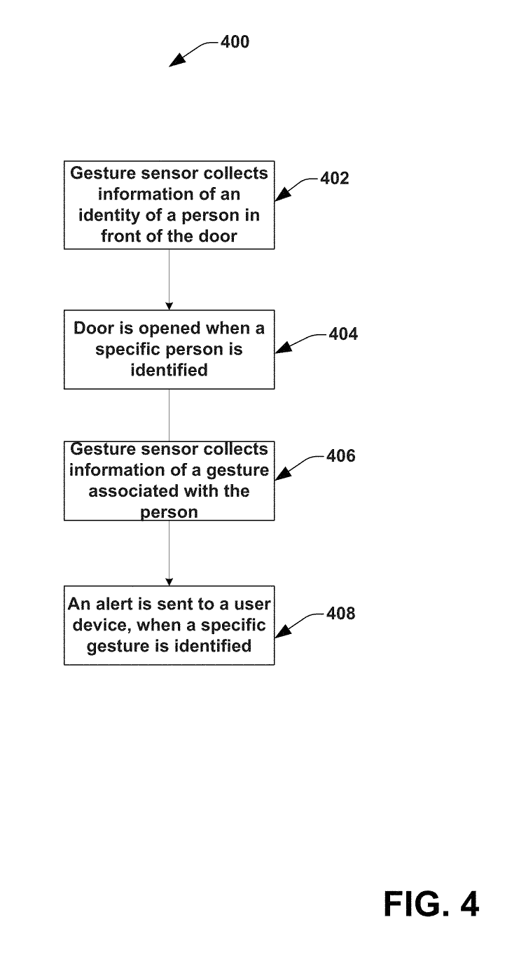

FIG. 4 illustrates a flow diagram 400 of a scenario of operation of a device associated with a door in a smart door system, according to one embodiment of the disclosure. In some embodiments, the device described herein is same as the device 200 in FIG. 2. In particular, the scenario of operation illustrated herein is applicable, when the sensor circuit 202 associated with the device 200 comprises a gesture sensor configured to collect information comprising an identity of a person in front of the door and at least one specific gesture associated with the person. The flow diagram 400 is explained herein with reference to the device 200 in FIG. 2. In this embodiment, the sensor circuit 202 associated with the device 200 is assumed to comprise a gesture sensor.

At 402, the gesture sensor (i.e., the sensor circuit 202) collects information of an identity of a person in front of the door, in order to identify a specific person. In some embodiments, the gesture sensor can comprise a facial recognition system capable of identifying one or more specific facial features of a person, in order to identify a specific person. However, in other embodiments, the gesture sensor can be configured to identify any other specific feature of a person, in order to identify a specific person. In some embodiments, the gesture sensor is capable of identifying a specific person from an image (e.g., a digital image or a video frame) of the person. In such embodiments, the gesture sensor can comprise a gesture camera (e.g., a still camera or a video camera or both) associated therewith, in order to take the image of person or object in front of the door (e.g., the person's face). In some embodiments, the image from the camera can comprise images associated with multiple persons. In some embodiments, a processing circuit associated with the gesture sensor (e.g., the processing circuit 204) is configured to process the information associated with the person from the gesture sensor (e.g., the image), in order to identify a specific person. In some embodiments, the specific person can be a house owner or any other predefined person.

In such embodiments, the processing circuit 204 can be configured to identify some selected facial features or some other predefined features of the person from the information (e.g., the image) from the gesture sensor, and compare it to a predefined information associated with the person (e.g., a predefined facial feature or other predefined feature or a stored image), in accordance with a predefined set of instructions associated with the gesture sensor or in accordance with some predetermined facial recognition algorithms. In one example scenario, the facial recognition algorithm may analyze features like the relative position, size, and/or shape of the eyes, nose, cheekbones, jaw etc. from the image and compare these features with the predefined information. In some embodiments, the processing circuit 204 can comprise a memory circuit associated therewith configured to store the predefined information associated with the person.

Upon identifying the specific person, at 404, the door is opened. In such embodiments, the processing circuit 204 is configured to generate a control signal to open the door, when the specific person is identified. In some embodiments, the processing circuit 204 is configured to provide the control signal generated to the control circuit 206, in order to open the door. At 406, the gesture sensor (i.e., the sensor circuit 202) further collects information of a gesture associated with the person in front of the door, in order to identify a specific gesture associated with the specific person. In some embodiments, the specific gesture can include some predefined gestures like thumbs down, thumbs up etc. In some embodiments, collecting the identity of the person (i.e., the action at 402) and the gesture (i.e., the action at 406), can occur at the gesture sensor, at the same time. In some embodiments, the image taken by the gesture camera at 402 can be utilized to identify the specific gesture. However, in other embodiments, the gesture camera can be configured to take another image (based on a trigger, like detecting motion in front of the camera) of the person, in order to identify the specific gesture.

In some embodiments, the processing circuit 204 is configured to process the information associated with the gesture (e.g., the image) from the gesture sensor, in order to identify the specific gesture. In some embodiments, the processing circuit 204 is configured to perform the gesture recognition, only if the specific person is identified therebefore. In some embodiments, the specific gesture is associated to the specific person, if the specific person is identified at the processing circuit 204 (similar to action 402 above), prior to identifying the specific gesture. In some embodiments, the processing circuit 204 is configured to identify a specific gesture, in accordance with a predefined set of instructions associated with the processing circuit 204 or a gesture recognition algorithm. For example, in one embodiment, the processing circuit 204 or the gesture recognition algorithm can be configured to analyze some predefined or selected features associated with the gesture from the image and compare it to some predefined information about the gesture, in order to identify the specific gesture. In some embodiments, the predefined information about the gesture can comprise more general information regarding the gesture, like shape of the palm, orientation etc. However, in other embodiments, the predefined information about the gesture can comprise more specific information, like specific measurements of the gesture (e.g., the thumbs down) for a specific person.

Upon identifying the specific gesture associated with the specific person, at 408, an alert is sent to a user device. In such embodiments, the processing circuit 204 is configured to send the generated control signal or an alert signal associated with the control signal to the user device. In some embodiments, the control signal and the alert signal are the same. In some embodiments, the processing circuit 204 is configured to send the generated control signal to the user device only when both the specific person (the action at 402) and the specific gesture (the action at 406) has been identified and when the specific gesture is identified only after identifying the specific person. In such embodiments, the control signal provides an indication to the user device about the presence of the object in front of the door. In some embodiments, the user device comprises a user device associated with a regulatory authority, for example, 911 or police. However, other kinds of user devices, for example, smart phones or tablets etc. associated with a user are also contemplated to be within the scope of this disclosure. In some embodiments, the secondary feature associated with the gesture sensor (i.e., identifying the specific gesture associated with the specific person, for example, the owner) enables to alert respective authorities during emergency situations (e.g., when the owner is threatened to open the door by a stranger).

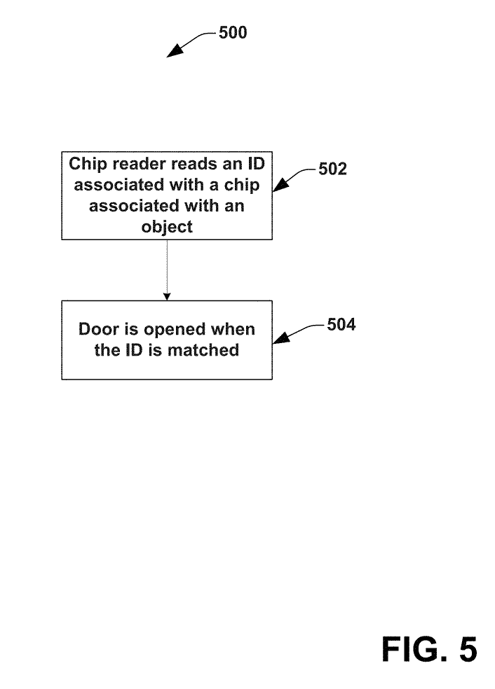

FIG. 5 illustrates a flow diagram 500 of a scenario of operation of a device associated with a door in a smart door system, according to one embodiment of the disclosure. In some embodiments, the device described herein is same as the device 200 in FIG. 2. In particular, the scenario of operation illustrated herein is applicable, when the sensor circuit 202 associated with the device 200 comprises a chip reader configured to identify a matching chip ID associated with an object in front of the door or a predefined area surrounding the door. The flow diagram 500 is explained herein with reference to the device 200 in FIG. 2. In this embodiment, the sensor circuit 202 associated with the device 200 is assumed to comprise a chip reader. In some embodiments, the chip reader comprises a near field communication (NFC) chip configured to identify a matching ID on a chip (e.g., an NFC chip) associated with an object in a predefined area surrounding the door (e.g., a chip implanted on a pet).

In one example scenario, if a chip is implanted on a pet, the NFC chip on the door senses a matched ID associated with the chip implanted on the pet and opens the door or a secondary door associated therewith, to let the pet go through. At 502, a chip reader (i.e., the sensor circuit 202 in FIG. 2) on the door reads an ID associated with a chip associated with an object (e.g., a pet) in a predefined area surrounding the door. In such embodiments, referring back to FIG. 2, the processing circuit 204 is configured to process the chip ID from the sensor circuit 202 and determines if the chip ID is a matching ID. At 504, the door is opened when the matching ID is identified. In such embodiments, the processing circuit 204, upon determining that the sensed chip ID is a matching ID, generates a control signal for opening the door or a secondary door associated therewith. In some embodiments, the processing circuit 204 is further configured to provide the control signal to the control circuit 206, in order to open the door.

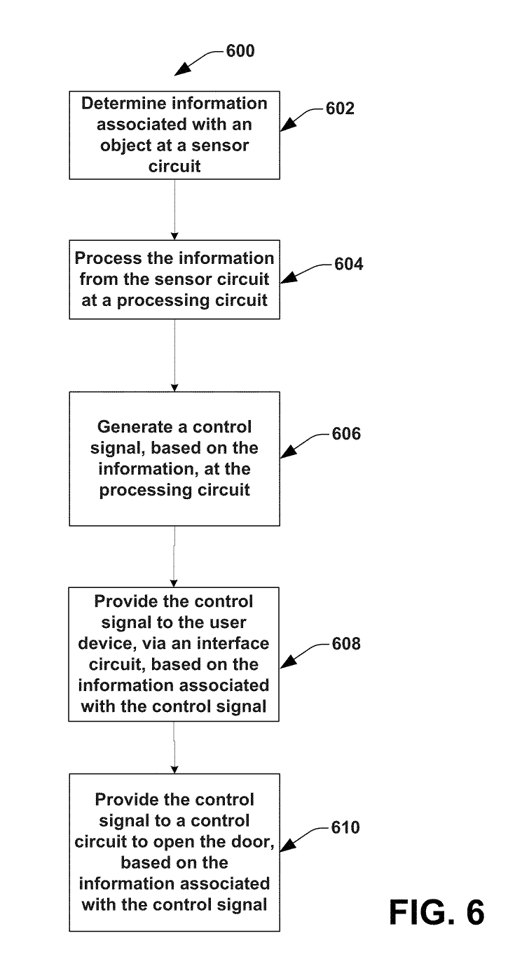

FIG. 6 illustrates a flow chart of a method 600 of a device associated with a door in a smart door system, according to one embodiment of the disclosure. The method is explained herein with respect to the device 200 in FIG. 2. At 602, information associated with an object in a predefined area surrounding the door is collected at a sensor circuit (e.g., the sensor circuit 202 in FIG. 2). At 604, information collected at the sensor circuit is processed at a processing circuit (e.g., the processing circuit 204 in FIG. 2). At 606, a control signal is generated at the processing circuit, based on the information from the sensor circuit. At 608, the control signal is provided by the processing circuit to a user device, via an interface circuit (e.g., the interface circuit 208 in FIG. 2), based on the information associated with the control signal. In some embodiments, the control signal indicates the presence of the object to the user device. Alternately, in other embodiments, the processing circuit can choose not to provide the control signal to the user device. At 610, the control signal is provided by the processing circuit to a control circuit (e.g., the control circuit 206) to open the door, based on the information associated with the control signal. Alternately, in other embodiments, the processing circuit can choose not to provide the control signal to the control circuit.

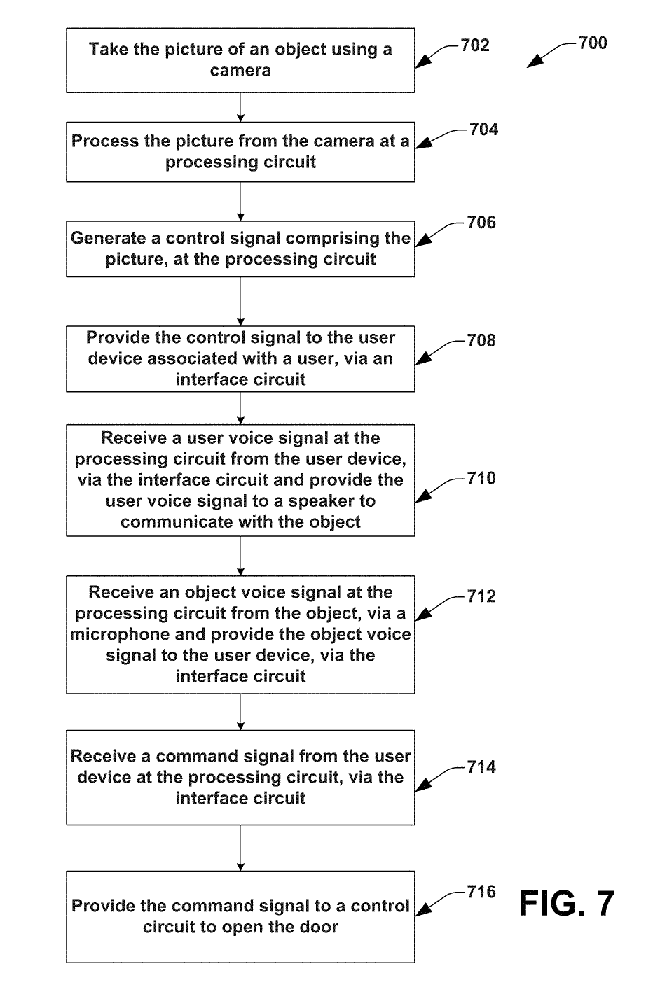

FIG. 7 illustrates a flow chart of a method 700 of a device associated with a door in a smart door system, according to one embodiment of the disclosure. The method is explained herein with respect to the device 200 in FIG. 2 and the scenario of operation illustrated in the flow diagram 300 in FIG. 3. In this embodiment, the sensor circuit 202 in FIG. 2 is assumed to comprise a camera configured to take the picture of an object in a predefined area surrounding the door. At 702, a picture of an object in front of or in the predefined area surrounding the door is taken at the camera (i.e., the sensor circuit 202 in FIG. 2). In some embodiments, the camera is configured to take the picture of the object, when a door bell associated with the door is rung. Alternately, in other embodiments, the camera is configured to take the picture of the object, when someone (e.g., a person or an object) stays in the predefined area for more than a predetermined interval of time (e.g., 1 minute).

At 704, the picture from the camera is processed at the processing circuit (e.g., the processing circuit 204 in FIG. 2). At 706, a control signal comprising the picture is generated at the processing circuit. At 708, the control signal comprising the picture is provided to a user device. In some embodiments, the user device is associated with a user, for example, the house owner. In some embodiments, the control signal provides an indication to the user about the presence of the object in front of the door. At 710, a user voice signal is received at the processing circuit from the user device, via the interface circuit and provided to a speaker (e.g., the communication circuit 210 in FIG. 2) to communicate with the object. At 712, an object voice signal is received at the processing circuit from the object, via a microphone (e.g., the communication circuit 210 in FIG. 2) and provided to the user device, via the interface circuit. At 714, a command signal is received at the processing circuit from the user device, via an interface circuit (e.g., the interface circuit 208 in FIG. 2). In some embodiments, the command signal is received at the processing circuit, in response to providing the control signal to the user device (i.e., the action at 708) or in response to the communication between the user and the object (i.e., the action at 710 and 712), via the communication circuit or both. In some embodiments, the command signal is generated at the user device based on a user command from the user to open the door. At 716, the control signal is provided from the processing circuit to a control circuit (e.g., the control circuit 206 in FIG. 2) to open the door.

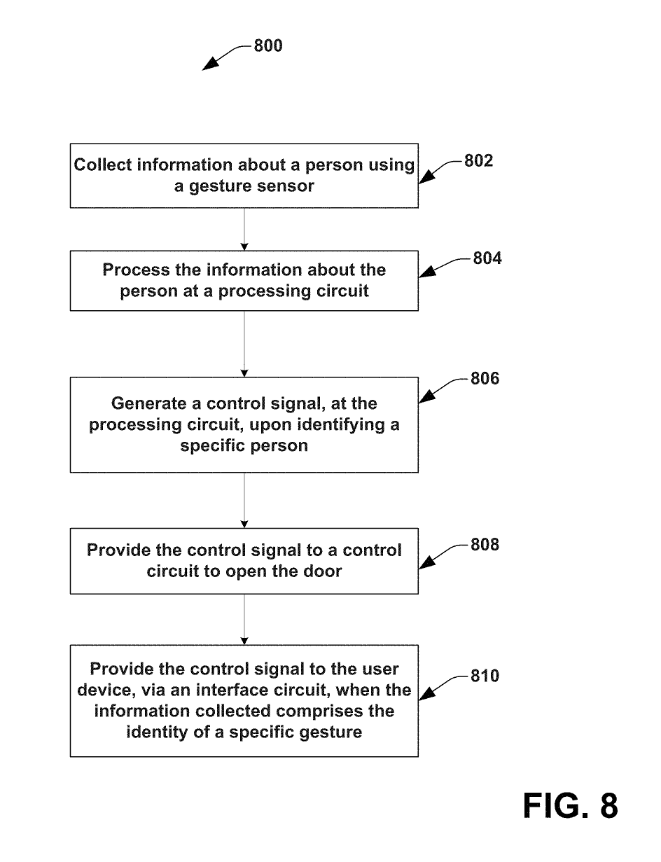

FIG. 8 illustrates a flow chart of a method 800 of a device associated with a door in a smart door system, according to one embodiment of the disclosure. The method is explained herein with respect to the device 200 in FIG. 2 and the scenario of operation illustrated in the flow diagram 400 in FIG. 4. In this embodiment, the sensor circuit 202 in FIG. 2 is assumed to comprise a gesture sensor configured to collect information of a person in a predefined area surrounding the door. At 802, information associated with a person in a predefined area surrounding the door is collected at a gesture sensor (e.g., the sensor circuit 202 in FIG. 2). In some embodiments, the gesture sensor is configured to collect facial features or some other predefined features of a person in order to identify a specific person. In some embodiments, the gesture sensor is further configured to collect information on a predefined gesture (e.g., thumbs up) associated with a person, in order to identify the specific gesture associated with the specific person. In some embodiment, the gesture sensor can comprise a gesture camera, in order to collect information about the person in front of the door.

At 804, the information collected at the gesture sensor is processed at the processing circuit (e.g., the processing circuit 204 in FIG. 2). At 806, a control signal is generated at the processing circuit, upon identifying the specific person based on the information from the gesture sensor. At 808, the control signal is provided to a control circuit (e.g., the control circuit 206 in FIG. 2) to open the door. At 810, the control signal is provided to a user device, via the interface circuit (e.g., the interface circuit 208 in FIG. 2), when the information collected at the gesture sensor comprises the identity of a specific gesture associated with the specific person. In some embodiments, the control signal is provided to the user device only if the specific person has been identified, prior to identifying the specific gesture. In some embodiments, the user device comprises a user device associated with a regulatory authority, for example, police or 911. However, in other embodiments, the user device can be associated with any user (e.g., a smart phone or a tablet). In some embodiments, the control signal indicates the user device about the presence of the object in front of or in the predefined area surrounding the door.

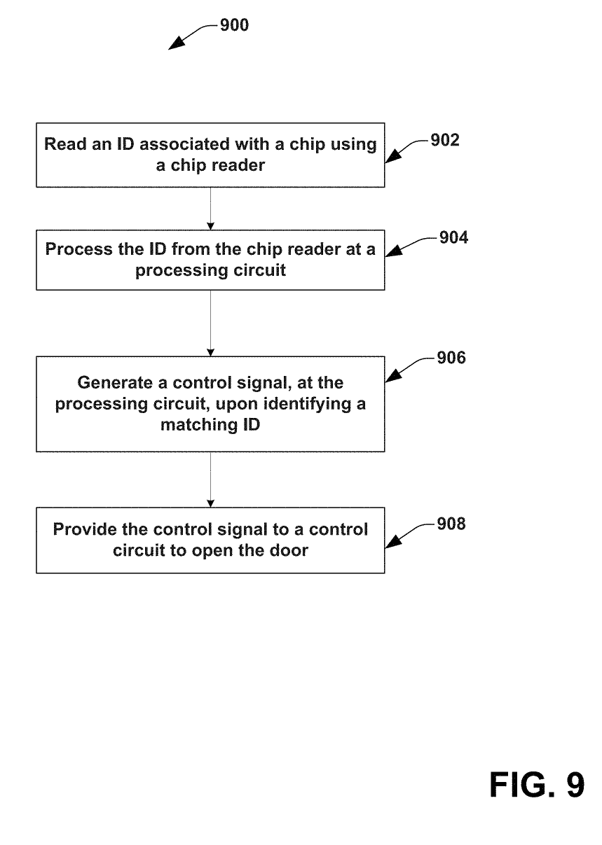

FIG. 9 illustrates a flow chart of a method 900 of a device associated with a door in a smart door system, according to one embodiment of the disclosure. The method is explained herein with respect to the device 200 in FIG. 2 and the scenario of operation illustrated in the flow diagram 500 in FIG. 5. In this embodiment, the sensor circuit 202 in FIG. 2 is assumed to comprise a chip reader configured to read an ID associated with a chip in a predefined area surrounding the door. At 902, an ID associated with a chip associated with an object in a predefined area surrounding the door is read at a chip reader (e.g., the sensor circuit 202 in FIG. 2). In some embodiments, the object may be a pet having a chip implanted. However, in other embodiments, the object may be anything else, for example, a non-living object, such as a key card, watch etc. At 904, the ID read at the chip reader is processed at a processing circuit (e.g., the processing circuit 204 in FIG. 2). At 906, a control signal is generated at the processing circuit, when a matching ID associated with the chip is identified. At 908, the control signal is provided to a control circuit (e.g., the control circuit 206 in FIG. 2), in order to open the door.

While the methods are illustrated, and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases.

While the apparatus has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature may have been disclosed with respect to only one of several implementations, such feature may be combined with one or more other features of the other implementations as may be desired and advantageous for any given or particular application.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

Example 1 is a device associated with a door comprising a sensor circuit comprising one or more sensors configured to collect information associated with an object in a predefined area surrounding the door; a processing circuit configured to process the information from the one or more sensors; generate a control signal for communicating to a user device, based on the information from the one or more sensors, wherein the control signal indicates the user device about the presence of the object in front of the door.

Example 2 is a device including the subject matter of example 1, wherein the one or more sensors comprises a camera configured to take a picture of the object in the predefined area surrounding the door, or a gesture sensor configured to collect information of a person in the predefined area surrounding the door, in order to identify the person and at least one specific gesture associated with the person, or both.

Example 3 is a device including the subject matter of examples 1-2, including or omitting elements, wherein the control signal is generated at the processing circuit when the information from the one or more sensors comprises the picture of the object from the camera, or an identity of a specific person or the specific gesture associated with the specific person from the gesture sensor.

Example 4 is a device including the subject matter of examples 1-3, including or omitting elements, wherein the control signal is provided to the user device, when the information associated with the control signal comprises the picture of the object from the camera or the identity of the specific gesture associated with the specific person from the gesture sensor.

Example 5 is a device including the subject matter of examples 1-4, including or omitting elements, further comprising a control circuit configured to open the door, based on the control signal or a signal associated therewith.

Example 6 is a device including the subject matter of examples 1-5, including or omitting elements, wherein the control signal is provided to the user device comprising a smart device associated with a user, when the information associated with the control signal comprises the picture of the object from the camera.

Example 7 is a device including the subject matter of examples 1-6, including or omitting elements, wherein the control circuit is configured to open the door, upon receiving a command signal from the user device, at the processing circuit, wherein the command signal is selectively received at the processing circuit from the user device, in response to providing the control signal comprising the picture of the object to the user device.

Example 8 is a device including the subject matter of examples 1-7, including or omitting elements, wherein the processing circuit is further configured to process a user voice signal received from the user device to be subsequently provided to the object, in response to providing the control signal comprising the picture of the object to the user device, prior to receiving the command signal from the user device.

Example 9 is a device including the subject matter of examples 1-8, including or omitting elements, wherein the processing circuit is further configured to process an object voice signal received from the object, to be subsequently provided to the user device, in response to providing the user voice signal to the object, prior to receiving the command signal from the user device.

Example 10 is a device including the subject matter of examples 1-9, including or omitting elements, further comprising a communication circuit comprising a first communication interface configured to provide the user voice signal from the processing circuit to the object and a second communication interface configured to receive the object voice signal from the object to be subsequently provided to the processing circuit.

Example 11 is a device including the subject matter of examples 1-10, including or omitting elements, wherein the control signal is provided to the user device comprising a device associated with a regulatory authority, when the information associated with the control signal comprises the identity of the specific gesture associated with the specific person from the gesture sensor.

Example 12 is a device including the subject matter of examples 1-11, including or omitting elements, wherein the control circuit is configured to open the door, based on the control signal, when the information associated with the control signal indicates that the specific person is identified or the specific gesture associated with the specific person is identified.

Example 13 is a device including the subject matter of examples 1-12, including or omitting elements, wherein the camera is configured to take the picture of the object under one or more predetermined conditions, wherein the predetermined conditions include a first predetermined condition where a door bell associated with the door is rung and a second predetermined condition where the object is detected in the predefined area surrounding the door for more than a predetermined time interval.

Example 14 is a device including the subject matter of examples 1-13, including or omitting elements, wherein the one or more sensors further comprises an infrared (IR) sensor configured to detect the presence of the object in the predefined area surrounding the door.

Example 15 is a device including the subject matter of examples 1-14, including or omitting elements, further comprising an interface circuit configured to exchange one or more signals between the processing circuit and the user device.

Example 16 is a device associated with a door comprising a sensor circuit comprising a camera configured to take a picture of an object in a predefined area surrounding the door; a processing circuit configured to process the picture from the camera; generate a control signal comprising the picture; and provide the control signal to a user device, wherein the control signal indicates the user device about the presence of the object in the predefined area surrounding the door.

Example 17 is a device including the subject matter of example 16, wherein the camera is configured to take the picture of the object in the predefined area surrounding the door, when a door bell associated with the door is rung or when the object is detected in the predefined area surrounding the door for more than a predetermined time interval.

Example 18 is a device including the subject matter of examples 16-17, including or omitting elements, wherein the sensor circuit further comprises an infrared (IR) sensor configured to detect the presence of the object in the predefined area surrounding the door.

Example 19 is a device including the subject matter of examples 16-18, including or omitting elements, wherein the processing circuit is further configured to receive a command signal from the user device, in response to providing the control signal to the user device.

Example 20 is a device including the subject matter of examples 16-19, including or omitting elements, further comprising a control circuit configured to open the door, based on the command signal received at the processing circuit, from the user device.

Example 21 is a device including the subject matter of examples 16-19, including or omitting elements, wherein the processing circuit is further configured to process a user voice signal received from the user device to be subsequently provided to the object, in response to providing the control signal to the user device, prior to receiving the command signal from the user device.

Example 22 is a device including the subject matter of examples 16-21, including or omitting elements, wherein the processing circuit is further configured to process an object voice signal received from the object, to be subsequently provided to the user device, in response to providing the user voice signal to the object, prior to receiving the command signal from the user device.

Example 23 is a device including the subject matter of examples 16-22, including or omitting elements, wherein the user device comprises a smart device associated with a user.

Example 24 is a device including the subject matter of examples 16-23, including or omitting elements, wherein the command signal is selectively generated at the user device based on a user command, in response to receiving the control signal or the object voice signal or both at the user device.

Example 25 is a device including the subject matter of examples 16-24, including or omitting elements, further comprising a communication circuit comprising a first communication interface configured to provide the user voice signal from the processing circuit to the object and a second communication interface configured to receive the object voice signal from the object to be subsequently provided to the processing circuit.

Example 26 is a device associated with a door comprising a sensor circuit comprising a gesture sensor configured to collect information comprising an identity of a person in a predefined area surrounding the door and at least one specific gesture associated with the person; a processing circuit configured to process information from the gesture sensor; generate a control signal based on the information from the gesture sensor; and provide the control signal to a user device, based on the information associated with the control signal, wherein the control signal indicates the presence of an object in the predefined area surrounding the door.

Example 27 is a device including the subject matter of example 26, wherein the control signal is generated at the processing circuit, when the information from the gesture sensor comprises at least the identity of a specific person.

Example 28 is a device including the subject matter of examples 26-27, including or omitting elements, wherein the control signal is provided to the user device from the processing circuit, when the information associated with the control signal comprises the identity of the specific person and the identity of the specific gesture associated with the specific person.

Example 29 is a device including the subject matter of examples 26-28, including or omitting elements, wherein the user device comprises a device associated with a regulatory authority.

Example 30 is a device including the subject matter of examples 26-29, including or omitting elements, further comprising a control circuit configured to open the door, based on the control signal generated at the processing circuit.

Example 31 is a method for a device associated with a door comprising taking a picture of an object in a predefined area surrounding the door, at a sensor circuit comprising a camera; processing the picture from the camera at a processing circuit; generating a control signal comprising the picture at the processing circuit; and providing the control signal from the processing circuit to a user device, wherein the control signal indicates the user device about the presence of the object in the predefined area surrounding the door.

Example 32 is a method including the subject matter of example 31, wherein the camera is configured to take the picture of the object in the predefined area surrounding the door, when a door bell associated with the door is rung or when the object is detected in the predefined area surrounding the door for more than a predetermined time interval.

Example 33 is a method including the subject matter of examples 31-32, including or omitting elements, wherein the sensor circuit further comprises an infrared (IR) sensor configured to detect the presence of the object in the predefined area surrounding the door.

Example 34 is a method including the subject matter of examples 31-33, including or omitting elements, further comprising receiving a command signal from the user device, in response to providing the control signal to the user device.

Example 35 is a method including the subject matter of examples 31-34, including or omitting elements, further comprising opening the door, based on the command signal received at the processing circuit, from the user device, using acontrol circuit.

Example 36 is a method including the subject matter of examples 31-35, including or omitting elements, wherein the user device comprises a smart device associated with a user.

Example 37 is a device associated with a door comprising a sensor circuit comprising a gesture sensor configured to collect information comprising an identity of a person in a predefined area surrounding the door, in order to identify a specific person and at least one specific gesture associated with the specific person; a processing circuit configured to process information from the gesture sensor; generate a gesture control signal based on the information from the gesture sensor; and provide the gesture control signal to a first user device, based on the information associated with the control signal, wherein the control signal indicates the presence of an object in the predefined area surrounding the door; and a control circuit coupled to the processing circuit, in order to open the door.

Example 38 is a device including the subject matter of example 37, wherein the processing circuit is configured to generate the gesture control signal, when the information from the gesture sensor comprises at least the identity of the specific person.

Example 39 is a device including the subject matter of examples 37-38, including or omitting elements, wherein the processing circuit is configured to provide the gesture control signal to the first user device, when the information associated with the gesture control signal comprises both the identity of the specific person and the identity of the specific gesture associated with the specific person, and when the specific gesture is identified after identifying the specific person.

Example 40 is a device including the subject matter of examples 37-39, including or omitting elements, wherein the first user device comprises a device associated with a regulatory authority.

Example 41 is a device including the subject matter of examples 37-40, including or omitting elements, wherein the control circuit is configured to open the door, based on the gesture control signal generated at the processing circuit.

Example 42 is a device including the subject matter of examples 37-41, including or omitting elements, wherein the gesture sensor comprises a facial recognition system configured to identify the specific person, based on one or more specific facial features of the person.

Example 43 is a device including the subject matter of examples 37-42, including or omitting elements, wherein the sensor circuit further comprises a camera configured to take a picture of an object in a predefined area surrounding the door.

Example 44 is a device including the subject matter of examples 37-43, including or omitting elements, wherein the processing circuit is further configured to process the picture from the camera; generate a picture control signal comprising the picture; and provide the picture control signal to a second user device, wherein the picture control signal indicates the second user device about the presence of the object in the predefined area surrounding the door.

Example 45 is a device including the subject matter of examples 37-44, including or omitting elements, wherein the camera is configured to take the picture of the object in the predefined area surrounding the door, when a door bell associated with the door is rung or when the object is detected in the predefined area surrounding the door for more than a predetermined time interval.

Example 46 is a device including the subject matter of examples 37-45, including or omitting elements, wherein the sensor circuit further comprises an infrared (IR) sensor configured to detect the presence of the object in the predefined area surrounding the door.

Example 47 is a device including the subject matter of examples 37-46, including or omitting elements, wherein the processing circuit is further configured to receive a command signal from the second user device, in response to providing the picture control signal to the second user device.

Example 48 is a device including the subject matter of examples 37-47, including or omitting elements, wherein the control circuit is configured to open the door, based on the command signal received at the processing circuit, from the second user device.

Example 49 is a device including the subject matter of examples 37-48, including or omitting elements, wherein the processing circuit is further configured to process a user voice signal received from the second user device to be subsequently provided to the object, in response to providing the picture control signal to the user device, prior to receiving the command signal from the second user device.

Example 50 is a device including the subject matter of examples 37-49, including or omitting elements, wherein the processing circuit is further configured to process an object voice signal received from the object, to be subsequently provided to the second user device, in response to providing the user voice signal to the object, prior to receiving the command signal from the second user device.

Example 51 is a device associated with a door comprising a sensor circuit comprising one or more sensors configured to collect information associated with an object in a predefined area surrounding the door; a processing circuit configured to process the information from the one or more sensors; and generate a control signal for communicating to a user device, based on the information from the one or more sensors, wherein the control signal indicates the user device about the presence of the object in front of the door; and a control circuit coupled to the processing circuit, in order to open the door.

Example 52 is a device including the subject matter of example 51, wherein the one or more sensors comprises a gesture sensor configured to collect information of a person in the predefined area surrounding the door, in order to identify a specific person and at least one specific gesture associated with the specific person.

Example 53 is a device including the subject matter of examples 51-52, including or omitting elements, wherein the control signal is generated at the processing circuit when the information from the one or more sensors comprises at least an identity of the specific person.

Example 54 is a device including the subject matter of examples 51-53, including or omitting elements, wherein the control signal is provided to the user device comprising a device associated with a regulatory authority, when the information associated with the control signal further comprises the identity of the specific gesture associated with the specific person, and when the specific gesture is identified after identifying the specific person at the processing circuit.

Example 55 is a device including the subject matter of examples 51-54, including or omitting elements, wherein the control circuit is configured to open the door, based on the generated control signal.

Example 56 is a device including the subject matter of examples 51-55, including or omitting elements, wherein the one or more sensors comprises a camera configured to take a picture of the object in the predefined area surrounding the door.

Example 57 is a device including the subject matter of examples 51-56, including or omitting elements, wherein the control signal is generated at the processing circuit when the information from the one or more sensors comprises the picture of the object, and wherein the control signal generated comprises the picture of the object.

Example 58 is a device including the subject matter of examples 51-57, including or omitting elements, wherein the control signal is provided to the user device comprising a device associated with a user, when the control signal comprises the picture of the object from the camera.

Example 59 is a method for a device associated with a door comprising collecting information comprising an identity of a person in a predefined area surrounding the door and at least one specific gesture associated with the person, at a sensor circuit comprising a gesture sensor; processing the information from the gesture sensor, at a processing circuit; generating a control signal based on the information from the gesture sensor, at the processing circuit; and providing the control signal from the processing circuit to a user device associated with a regulatory authority, based on the information associated with the control signal, wherein the control signal indicates the presence of an object in the predefined area surrounding the door.

Example 60 is a method including the subject matter of example 59, wherein the control signal is generated at the processing circuit, when the information from the gesture sensor comprises at least the identity of a specific person.

Example 61 is a method including the subject matter of examples 59-60, including or omitting elements, wherein the gesture control signal is provided to the first user device from the processing circuit, when the information associated with the gesture control signal comprises both the identity of the specific person and the identity of the specific gesture associated with the specific person, and when the specific gesture is identified at the processing circuit after identifying the specific person.

Various illustrative logics, logical blocks, modules, and circuits described in connection with aspects disclosed herein can be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A device associated with a door comprising:
a sensor circuit comprising a gesture sensor configured to collect information comprising an identity of a person in a predefined area surrounding the door, in order to identify a specific person and at least one specific gesture associated with the specific person;
a processing circuit configured to:
process information from the gesture sensor;
generate a gesture control signal based on the information from the gesture sensor; and
provide the gesture control signal to a first user device, based on the information associated with the control signal, wherein the control signal indicates the presence of an object in the predefined area surrounding the door; and
a control circuit coupled to the processing circuit, in order to open the door.

2. The device of claim 1, wherein the processing circuit is configured to generate the gesture control signal, when the information from the gesture sensor comprises at least the identity of the specific person.

3. The device of claim 1, wherein the processing circuit is configured to provide the gesture control signal to the first user device, when the information associated with the gesture control signal comprises both the identity of the specific person and the identity of the specific gesture associated with the specific person, and when the specific gesture is identified after identifying the specific person.

4. The device of claim 1, wherein the first user device comprises a device associated with a regulatory authority.

5. The device of claim 1, wherein the control circuit is configured to open the door, based on the gesture control signal generated at the processing circuit.

6. The device of claim 1, wherein the gesture sensor comprises a facial recognition system configured to identify the specific person, based on one or more specific facial features of the person.

7. The device of claim 1, wherein the sensor circuit further comprises a camera configured to take a picture of an object in a predefined area surrounding the door.

8. The device of claim 7, wherein the processing circuit is further configured to:
process the picture from the camera;
generate a picture control signal comprising the picture; and
provide the picture control signal to a second user device, wherein the picture control signal indicates the second user device about the presence of the object in the predefined area surrounding the door.

9. The device of claim 7, wherein the camera is configured to take the picture of the object in the predefined area surrounding the door, when a door bell associated with the door is rung or when the object is detected in the predefined area surrounding the door for more than a predetermined time interval.

10. The device of claim 9, wherein the sensor circuit further comprises an infrared (IR) sensor configured to detect the presence of the object in the predefined area surrounding the door.

11. The device of claim 8, wherein the processing circuit is further configured to receive a command signal from the second user device, in response to providing the picture control signal to the second user device.

12. The device of claim 11, wherein the control circuit is configured to open the door, based on the command signal received at the processing circuit, from the second user device.

13. The device of claim 11, wherein the processing circuit is further configured to process a user voice signal received from the second user device to be subsequently provided to the object, in response to providing the picture control signal to the user device, prior to receiving the command signal from the second user device.

14. The device of claim 13, wherein the processing circuit is further configured to process an object voice signal received from the object, to be subsequently provided to the second user device, in response to providing the user voice signal to the object, prior to receiving the command signal from the second user device.

15. A device associated with a door comprising:
a sensor circuit comprising one or more sensors configured to collect information associated with an object in a predefined area surrounding the door;
a processing circuit configured to:
process the information from the one or more sensors; and
generate a control signal for communicating to a user device, based on the information from the one or more sensors, wherein the control signal indicates the user device about the presence of the object in front of the door; and
a control circuit coupled to the processing circuit, in order to open the door.

16. The device of claim 15, wherein the one or more sensors comprises a gesture sensor configured to collect information of a person in the predefined area surrounding the door, in order to identify a specific person and at least one specific gesture associated with the specific person.

17. The device of claim 16, wherein the control signal is generated at the processing circuit when the information from the one or more sensors comprises at least an identity of the specific person.

18. The device of claim 17, wherein the control signal is provided to the user device comprising a device associated with a regulatory authority, when the information associated with the control signal further comprises the identity of the specific gesture associated with the specific person, and when the specific gesture is identified after identifying the specific person at the processing circuit.

19. The device of claim 17, wherein the control circuit is configured to open the door, based on the generated control signal.

20. The device of claim 15, wherein the one or more sensors comprises a camera configured to take a picture of the object in the predefined area surrounding the door.

21. The device of claim 20, wherein the control signal is generated at the processing circuit when the information from the one or more sensors comprises the picture of the object, and wherein the control signal generated comprises the picture of the object.

22. The device of claim 21, wherein the control signal is provided to the user device comprising a device associated with a user, when the control signal comprises the picture of the object from the camera.

23. A method for a device associated with a door comprising:
collecting information comprising an identity of a person in a predefined area surrounding the door and at least one specific gesture associated with the person, at a sensor circuit comprising a gesture sensor;
processing the information from the gesture sensor, at a processing circuit;
generating a control signal based on the information from the gesture sensor, at the processing circuit; and
providing the control signal from the processing circuit to a user device associated with a regulatory authority, based on the information associated with the control signal, wherein the control signal indicates the presence of an object in the predefined area surrounding the door.

24. The method of claim 23, wherein the control signal is generated at the processing circuit, when the information from the gesture sensor comprises at least the identity of a specific person.

25. The method of claim 23, wherein the gesture control signal is provided to the first user device from the processing circuit, when the information associated with the gesture control signal comprises both the identity of the specific person and the identity of the specific gesture associated with the specific person, and when the specific gesture is identified at the processing circuit after identifying the specific person.
